(19) United States
(12) Patent Application Publication
(10) Pub. No.: US 2018/0228280 A1
(43) Pub. Date: Aug. 16, 2018

(54) Connecting Device For Mobile Terminal Support, Beverage Bottle And Mobile Terminal Support

(71) Applicant: Zhuhai New Stone Technology Co., Ltd., Zhuhai (CN)

(72) Inventors: Xiaoning Li, Zhuhai (CN); Maoliang Ji, Zhuhai (CN); Chuanjin Cai, Zhuhai (CN)

(73) Assignee: Zhuhai New Stone Technology Co., Ltd., Zhuhai (CN)

(21) Appl. No.: 15/509,342

(22) PCT Filed: Nov. 17, 2016
(86) PCT No.: PCT/CN2016/106256

§ 371 Date: Mar. 7, 2017

(30) Foreign Application Priority Data
Nov. 2, 2016 (CN) 201610949411.4

(51) Int. Cl. A47B 23/06; B65D 41/04; B65D 51/24; F16M 11/10; F16M 13/02

(52) U.S. Cl. CPC A47B 23/06; B65D 41/04; F16M 13/02; F16M 11/10; B65D 51/24

(57) ABSTRACT

The present invention provides a connecting device, a beverage bottle, and a mobile terminal support comprising the beverage bottle. A first protrusion and a second protrusion which are sequentially connected are arranged on a main body of the connecting device; the first protrusion is eccentrically arranged relative to the main body, and the first and second protrusions are concentrically arranged. A mobile terminal ring buckle pasted on the back side of a mobile phone sleeves the first protrusion, and the second protrusion limits the ring buckle. The mobile phone is fixedly supported when the mobile terminal ring buckle sleeves the beverage bottle. Meanwhile, by setting the size relations among the first protrusion, the second protrusion and the bottle cap main body, the mobile terminal support may become a portable support through which the raising angle of the mobile phone can be adjusted.

### TECHNICAL FIELD

The present invention relates to the field of fixed supporting apparatuses, and more particularly to a connecting device for a mobile terminal support, a beverage bottle that can be used as the mobile terminal support, and the mobile terminal support based on the beverage bottle. The present invention is based on the Chinese Patent Application No. CN201610949411.4, which was filed on Nov. 2, 2016 and is incorporated herein by reference in its entirety.

### BACKGROUND ART

As requirements of users on mobile terminals such as mobile phones, e-book readers and tablet computers are increasing, the processing speed, screen display quality and screen sizes of mobile terminals are gradually improved or increased. For example, existing smart mobile phones are difficult to hold by one hand because of their larger sizes, so people design a mobile terminal ring buckle. After a paste board of the mobile terminal ring buckle is pasted on the back of a mobile phone, a user's finger can pass through a ring member of the mobile terminal ring buckle to fix the mobile phone when holding it.

When an existing two-side clamping type support clamps the mobile phone mounted with a mobile phone ring buckle, the stability of the mobile phone clamped by a clamping holder of the two-side clamping type support is poor due to a certain thickness of the mobile phone ring buckle mounted on the back of the mobile phone. Alternatively, it is required to design the clamping type support with a larger clamping thickness. However, when a clamping holder with a larger clamping thickness clamps a mobile phone without a mobile phone ring buckle, the excessive thickness may be sufficient to cause shifting or even falling of the mobile phone while the mobile phone vibrates.

The present invention provides a portable and easy-to-use support which can cooperate with existing mobile terminal ring buckles.

### Technical Problems

A first object of the present invention is to provide a connecting device for a mobile terminal support that can cooperate with a mobile terminal ring buckle in use.

A second object of the present invention is to provide a beverage bottle which can be used as the mobile terminal support.

A third object of the present invention is to provide the mobile terminal support comprising the beverage bottle and the mobile terminal ring buckle.

### Technical Solutions

According to the first object of the present invention, there is provided a connecting device comprising a cylindrical bottle cap main body, wherein a matching member is arranged at the lower part of the main body; the upper end of the main body is connected with a first protrusion, the upper end of the first protrusion is connected with a second protrusion, and the first protrusion is eccentrically arranged relative to the main body; in the axial direction of the connecting device, a projection plane of the second protrusion on the bottle cap main body is completely located within a peripheral contour line of the bottle cap main body, and an area of the projection plane of the second protrusion on the bottle cap main body is smaller than that of the surface formed by the peripheral contour line of the bottle cap main body; and in the extending direction of the first protrusion, a projection plane of the first protrusion on the second protrusion is completely located within a peripheral contour line of the second protrusion, and an area of the projection plane of the first protrusion on the second protrusion is smaller than that of the surface formed by the peripheral contour line of the second protrusion.

Further, in the extending direction of the first protrusion, the cross sections of the first and second protrusions are both circular, and the second protrusion is coaxially arranged with the first protrusion.

Further, an eccentric circular truncated cone is connected between the main body and the first protrusion, the upper end surface of the main body is concentrically connected with the lower end surface of the eccentric circular truncated cone, and the lower end surface of the first protrusion is concentrically connected with the upper end surface of the eccentric circular truncated cone.

Further, a ring of annular protrusion is arranged at the joints between the eccentric circular truncated cone and the periphery of the main body.

Further, the lower end of the main body is open, and the matching member is located in an opening at the lower end of the main body; and the matching member is a thread formed on the inner wall of the opening or a matching cushion block arranged on the inner wall of the opening.

Further, the matching member is a screw hole part arranged at the lower part of the main body.

According to the second object of the present invention, there is provided a beverage bottle comprising a bottle cap and a bottle body, wherein the bottle cap comprises a circular bottle cap main body, and a matching member is arranged at the lower part of the bottle cap main body, and is matched with the bottle body to seal a mouth at the upper end of the bottle body. The upper end of the bottle cap main body is connected with a first protrusion, the upper end of the first protrusion is connected with a second protrusion, and the first protrusion is eccentrically arranged relative to h the bottle cap main body; in the axial direction of the bottle cap, a projection plane of the second protrusion on the bottle cap main body is completely located within a peripheral contour line of the bottle cap main body, and an area of the projection plane of the second protrusion on the bottle cap main body is smaller than that of the surface formed by the peripheral contour line of the bottle cap main body; in the extending direction of the first protrusion, a projection plane of the first protrusion on the second protrusion is completely located within a peripheral contour line of the second protrusion, and an area of the projection plane of the first protrusion on the second protrusion is smaller than that of the surface formed by the peripheral contour line of the second protrusion; and a ring member detachably sleeves the first protrusion, and the second protrusion limits the ring member.

Further, in the extending direction of the first protrusion, the cross sections of the first and second protrusions are both circular, and the second protrusion is coaxially arranged with the first protrusion.

According to the third object of the present invention, there is provided a mobile terminal support comprising a mobile terminal ring buckle, wherein the mobile terminal ring buckle comprises a paste board, a rotating shaft and a ring member; the paste board comprises a first side and a second side opposite to the first side, a viscous layer is arranged on the first side, the rotating shaft is rotatably connected with the second side, and the ring member is rotatably connected onto the rotating shaft. The mobile terminal support further comprises a beverage bottle comprising a bottle cap and a bottle body, wherein the bottle cap comprises a circular bottle cap main body, and a matching member is arranged at the lower part of the bottle cap main body, and is matched with the bottle body to seal a mouth at the upper end of the bottle body; the upper end of the bottle cap main body is connected with a first protrusion, the upper end of the first protrusion is connected with a second protrusion, and the first protrusion is eccentrically arranged relative to the bottle cap main body; in the axial direction of the bottle cap, a projection plane of the second protrusion on the bottle cap main body is completely located within a peripheral contour line of the bottle cap main body, and an area of the projection plane of the second protrusion on the bottle cap main body is smaller than that of the surface formed by the peripheral contour line of the bottle cap main body; in the extending direction of the first protrusion, a projection plane of the first protrusion on the second protrusion is completely located within a peripheral contour line of the second protrusion, and an area of the projection plane of the first protrusion on the second protrusion is smaller than that of the surface formed by the peripheral contour line of the second protrusion; the ring member detachably sleeves the first protrusion, and the second protrusion limits the ring member; and the second side of the paste board or the rotating shaft is propped against the main body of the ring member.

Further, in the extending direction of the first protrusion, the cross sections of the first and second protrusions are both circular, and the second protrusion is coaxially arranged with the first protrusion.

### Beneficial Effects

The ring member of the mobile terminal ring buckle provided by the present invention may sleeve the first protrusion, and is in a fastening relation with the bottle cap under the limit of the second protrusion. Meanwhile, the mobile terminal ring buckle can rotate about the first protrusion. Based on designed size relations among the bottle cap main body, the first protrusion and the second protrusion as well as designed position relations thereamong, in the rotating process of the mobile terminal ring buckle, different raising angles of the paste board may be formed; that is, a tilt angle of a mobile terminal screen is adjustable, so that a portable and universal mobile terminal support can be formed as long as the connecting device is mounted on the bottle body.

In addition, the circular and coaxially arranged first and second protrusions may ensure the rotation smoothness of the mobile terminal ring buckle when the mobile terminal ring buckle is rotated to adjust a raising angle thereof.

Moreover, the eccentric circular truncated cone can improve mechanical properties of the connecting device, and a ring member arranging region formed by the eccentric circular truncated cone and the first protrusion is increased, so that the mounting of the mobile terminal ring buckle and the raising angle adjustment of the paste board may be further facilitated.

Furthermore, the second side of the paste board is propped against an annular protrusion, and the arranged annular protrusion can prevent the paste board from being damaged by excessive local pressure generated by sharp corners and the like.

In addition, the connecting device may be mounted on the bottle cap via the matching member or the matching member may replace the connecting device to be mounted on the bottle body.

Moreover, the connecting device may be connected to a holder on a support or a selfie stick via a screw hole part.

The ring member of the mobile terminal ring buckle provided by the present invention may sleeve the first protrusion, and is in a fastening relation with the bottle cap under the limit of the second protrusion. Meanwhile, the mobile terminal ring buckle can rotate about the first protrusion. The beverage bottle as a fluid container may become a portable and universal mobile terminal support at the same time.

In addition, the mobile terminal support provided by the present invention is formed mainly based on the beverage bottle. The first and second protrusions capable of matching with the mobile terminal ring buckle are arranged on the bottle cap. Under the action of a gravity center formed by the self weights of both the beverage bottle and a fluid in the bottle, a mobile terminal pasted on the paste board is naturally supported on the bottle cap. Meanwhile, as the first protrusion is eccentrically arranged relative to the bottle cap main body, when the mobile terminal and the mobile terminal ring buckle are rotated about the first protrusion, the ring member contacted the first protrusion at a first contacting point, and the second side of the paste board contacted the bottle cap main body at a second contacting point, and the distance between the first contacting point and the second contacting point is continuously changed, and the paste board continuously raises or swings downward to keep contacting against the bottle cap main body, thereby realizing continuous adjustment of a tilt angle of a mobile terminal screen. The present solution provides a new mobile terminal support formed by matching the general beverage bottle with the ring buckle.

### BRIEF DESCRIPTION OF THE DRAWINGS

FIG. 1 shows a structural view of a mobile terminal support according to an embodiment of the present invention.

FIG. 2 shows an exploded structural view of the mobile terminal support according to the embodiment of the present invention.

FIG. 3 shows a structural view of a bottle cap of the mobile terminal support according to an embodiment of the present invention.

FIG. 4 shows a structural view of a bottle cap according to an embodiment of the present invention from another view.

FIG. 5 shows a structural view of the bottle cap according to an embodiment of the present invention from yet another view.

FIG. 6 shows a structural view of a mobile terminal ring buckle of the mobile terminal support according to an embodiment of the present invention.

FIG. 7 shows a schematic drawing of a first use state of the mobile terminal support according to an embodiment of the present invention.

FIG. 8 is a schematic drawing of a second use state of the mobile terminal support according to an embodiment of the present invention.

FIG. 9 shows a schematic drawing of a third use state of the mobile terminal support according to an embodiment of the present invention.

FIG. 10 shows a structural view of a bottle cap of the mobile terminal support according to an embodiment of the present invention.

FIG. 11 shows a structural view of a connecting device according to an embodiment of the present invention.

The present invention will be described in detail below with reference to the accompanying drawings.

### DETAILED DESCRIPTION

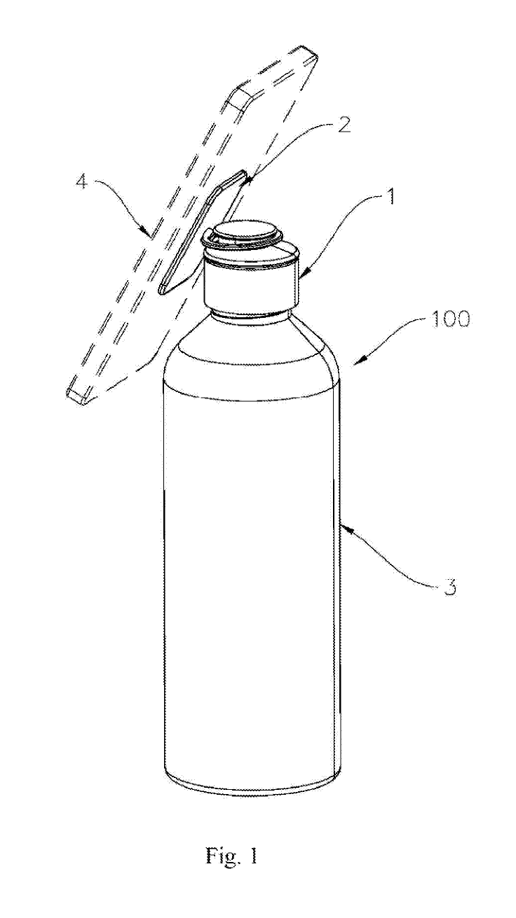

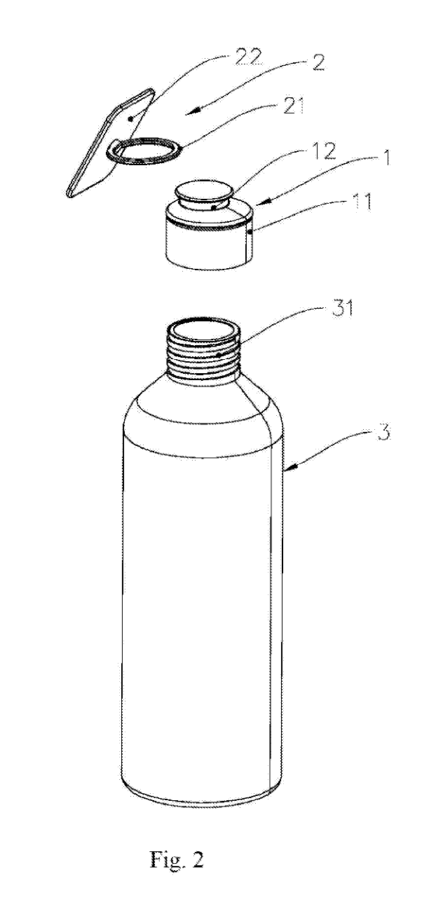

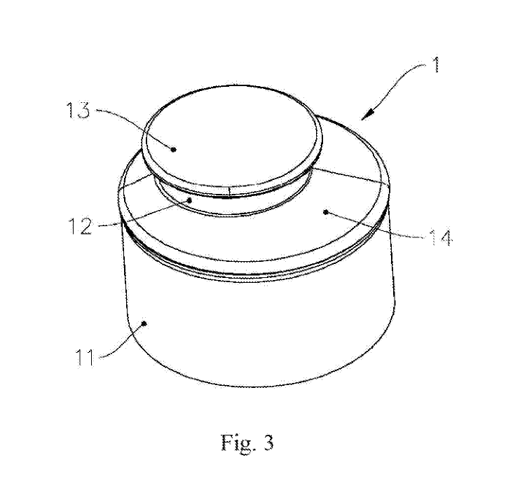

Referring to FIG. 1 and FIG. 2, FIG. 1 shows a structural view of a mobile terminal support, and FIG. 2 shows an exploded structural view of the mobile terminal support. The mobile terminal support is formed mainly based on the combined use of a beverage bottle 100 and a mobile terminal ring buckle 2. The mobile terminal ring buckle 2 comprises a paste board 22 to be connected with a mobile phone 4 in a pasted manner, a viscous layer is arranged at one side of the paste board 22, and a ring member 21 capable of rotating and allowing a finger to pass through is mounted on the other side of the paste board 22. The beverage bottle 100 comprises a bottle body 3, and a bottle cap 1, which is mounted at a mouth 31 of the bottle body 3 for sealing the mouth 31. A first protrusion 12 is arranged on the bottle cap 1; and the mobile phone 4 may be in buckled match with the beverage bottle 100 so long as the ring member 21 of the mobile terminal ring buckle 2 sleeves the first protrusion 12. The mobile phone 4 is fixedly supported as the gravity center of the beverage bottle 100 on which the mobile phone is mounted is located in the beverage bottle 100 under the action of the self weight of the beverage bottle 100 and the weight of the fluid in the beverage bottle 100, so that the beverage bottle can be retrofitted into the mobile terminal support. Of course, when there is no fluid inside the beverage bottle 100, the gravity center of the beverage bottle 100 on which the mobile phone 4 is mounted may still be located in the beverage bottle 100 if the contour of the bottle body 3 is mechanically analyzed and designed. Here, the beverage bottle is a daily fluid container, such as a mineral water bottle, a pop bottle or a fruit juice bottle, or even a beer bottle, a red wine bottle or other glass containers. Referring to FIG. 3, FIG. 3 shows a structural view of the bottle cap 1. The bottle cap 1 comprises a circular bottle cap main body 11. The lower end of the bottle cap main body 11 is open, and an internal thread matched with an external thread on the outer wall of the mouth is formed on the inner wall of the bottle cap main body 11. The upper part of the bottle cap main body 11 arches upward to form an eccentric circular truncated cone 14; the upper end of the eccentric circular truncated cone 14 is sequentially connected with the first protrusion 12 and the second protrusion 13; and the first protrusion 12 is a cylindrical protrusion, and the second protrusion 13 is a circular-disk protrusion.

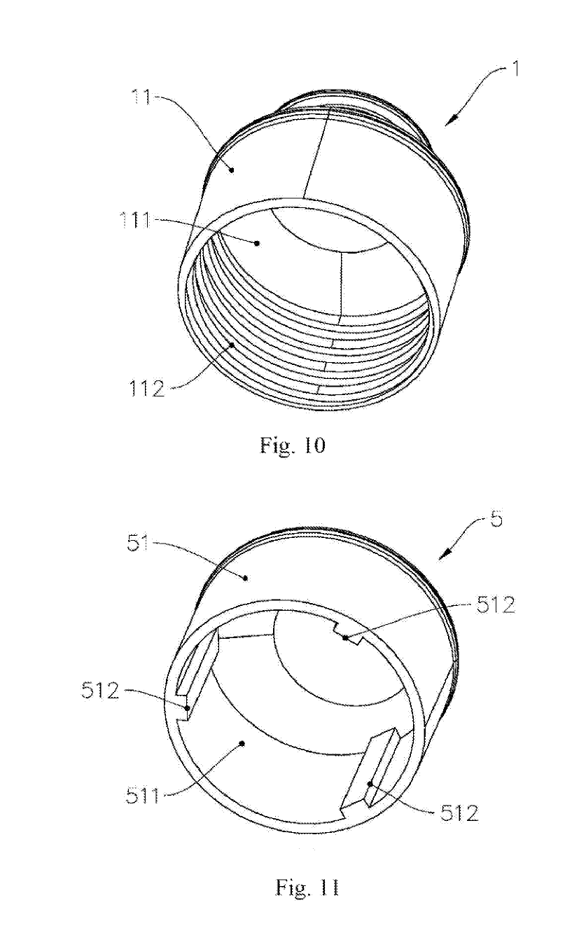

Referring to FIG. 10, FIG. 10 shows a structural view of the bottle cap according to a first embodiment. The bottle cap 1 in the first embodiment is used as a sealing member for sealing the opening of the bottle body. As the matching member arranged on the inner wall of an inner cavity 111 of the bottle cap main body 11 is an internal thread 112, a sealing effect on the bottle body can be realized by matching the internal thread 112 with the external thread on the opening of the bottle body.

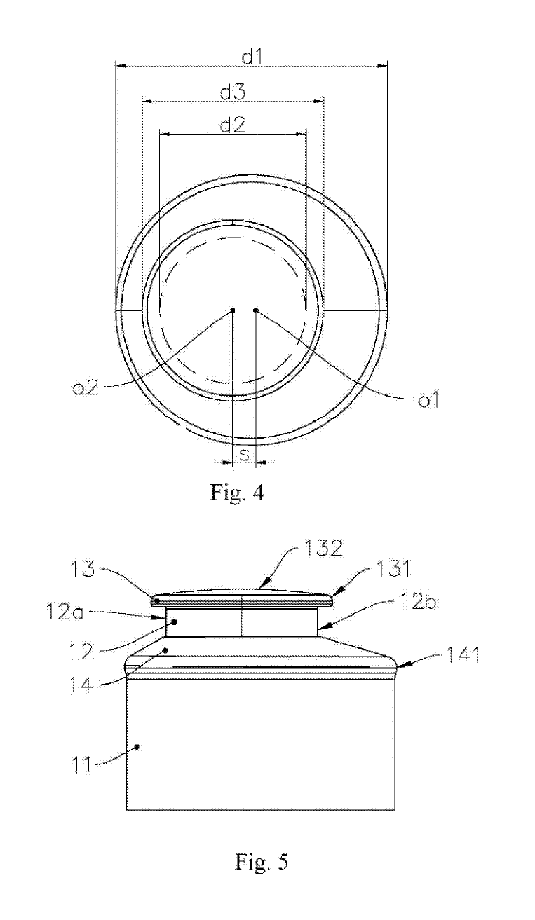

Referring to FIGS. 4 and 5, FIGS. 4 and 5 respectively show structural views of the bottle cap 1 from different views. The eccentric circular truncated cone 14 is provided with an upper end surface and a lower end surfaces parallel to each other, and a line formed by the center of the upper end surface and the center of the lower end surface is not perpendicular to the lower end surface of the eccentric circular truncated cone 14. The lower end surface of the eccentric circular truncated cone 14 is concentrically arranged with an upper end surface of the bottle cap main body 11, and each of the lower end surface of the eccentric circular truncated cone 14 and the bottle cap main body 11 is provided with a first center o1. The upper end surface of the eccentric circular truncated cone 14 is concentrically arranged with a lower end surface of the first protrusion 12. An upper end surface of the first protrusion 12 is concentrically arranged with a lower end surface of the second protrusion 13. The upper end surface of the eccentric circular truncated cone 14, the upper and lower end surfaces of the first protrusion 12, and the lower end surface of the second protrusion 13 are provided with second centers o2 respectively. If the first protrusion 12 and/or the second protrusion 13 is/are in other non-circular geometrical shapes, the concentric connection means that the second protrusion 13 is arranged at the central position of the first protrusion 12, and the eccentric connection means that the first protrusion 12 is connected onto the bottle cap main body 11, and the central position of the first protrusion 12 is not on the central axis of the bottle cap main body 11.

The central position of the end surface of the bottle cap main body 11 is different from that of the first protrusion 12; two eccentric limit positions are formed on the peripheral surface of the first protrusion 12 with respect to the bottle cap main body 11, namely, the nearest limit position 12a and the farthest limit position 12b. On the peripheral surface of the first protrusion 12, the distance from the nearest limit position 12a to the edge of the bottle cap main body 11 in the horizontal direction is the shortest, and the distance from the farthest limit position 12b to the edge of the bottle cap main body 11 in the horizontal direction is the longest. As the peripheral surfaces of both the bottle cap main body 11 and the first protrusion 12 are circular, during a process of moving from the nearest limit position 12a to the farthest limit position 12b on the peripheral surface of the first protrusion 12, namely, in a process of moving from the shortest distance between the first protrusion 12 and the bottle cap main body 11 to the longest distance therebetween, the distances from the peripheral surface of the first protrusion 12 to the edge of the bottle cap main body 11 change linearly.

In the present embodiment, the outer diameter d2 of the first protrusion 12 must be smaller than the outer diameter d1 of the bottle cap main body 11 to prevent the ring member buckled on the bottle cap main body 11 from sliding down; the outer diameter d3 of the second protrusion 13 must be larger than the outer diameter d2 of the first protrusion 12 to limit the upper part of the ring member in a clamping manner; and the outer diameter d3 of the second protrusion 13 must be smaller than the outer diameter d1 of the bottle cap main body 11 to avoid interference between the second protrusion 13 and a mobile phone or the paste board of the mobile terminal ring buckle.

Preferably, a ring of annular protrusions 141 are arranged at the joints between the periphery of the bottle cap main body 11 and the eccentric circular truncated cone 14; an inverted round corner 131 is arranged at the periphery of the second protrusion 13; the upper end surface of the second protrusion 13 is a spherical cap surface 132; and the bottle cap main body 11, the eccentric circular truncated cone 14, the first protrusion 12 and the second protrusion 13 are an integrally formed plastic member.

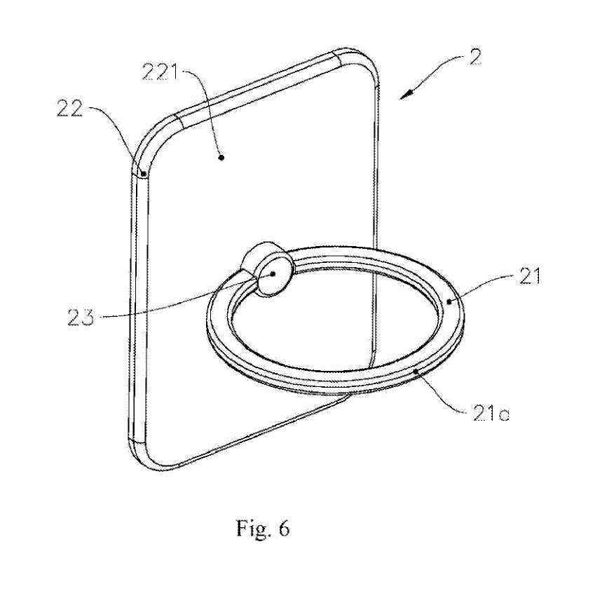

Referring to FIG. 6, FIG. 6 shows a structural view of a mobile terminal ring buckle 2. The mobile terminal ring buckle 2 comprises a paste board 22 and a ring member 21 connected onto a back side 221 of the paste board 2 and having rotation freedom in two directions. The paste board 22 comprises a first side and a second side which are opposite to each other; the ring member 21 is connected onto the back side 221 of the paste board 22 through a rotating shaft 23 which rotates relative to the paste board 22 with a normal line of the paste board 22 as the axis; and the ring member 21 is rotatably connected to the tail end of the rotating shaft 23, and rotates with a vertical line of the normal line of the paste board 22 as the axis. Here, as a mobile terminal such as a mobile phone, a tablet computer or an e-book reader is pasted onto the paste board 22, under the self weight of the mobile terminal, a supporter (such as the first protrusion) passing through the ring member 21 is propped against a propping point 21a, far away from the paste board 22, on the ring member 21.

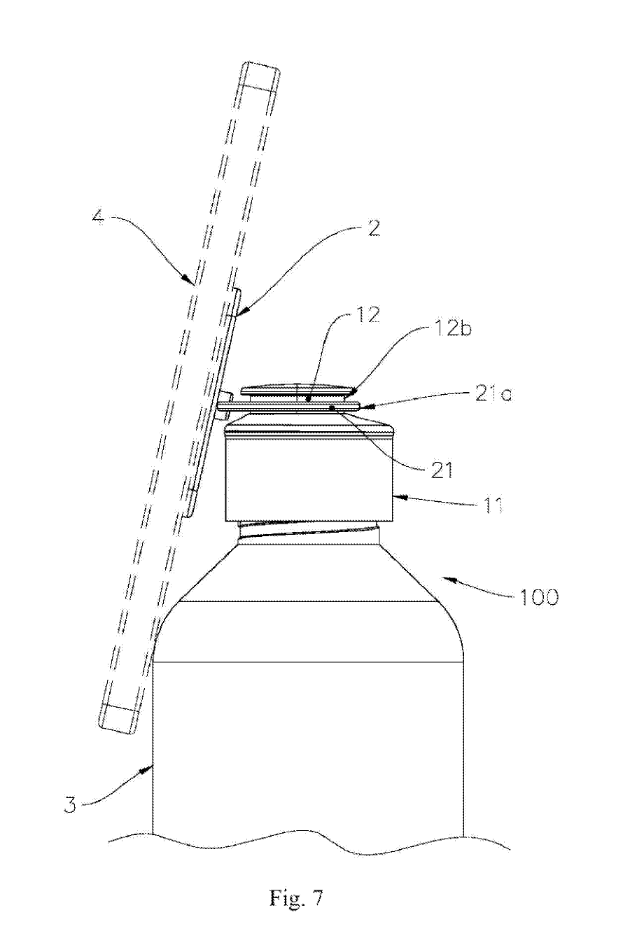

Referring to FIG. 7, FIG. 7 shows a schematic drawing of a first use state of the mobile terminal support. A mobile phone 4 is supported on the beverage bottle 100 by the mobile terminal ring buckle 2, and the propping point 21a on the ring member 21 of the mobile terminal ring buckle 2 is propped against the farthest limit position 12b of the first protrusion 12. Here, the distance from the mobile phone 4 to the center of the bottle cap main body 11 is the longest, and the lower part of the mobile phone 4 is propped against the bottle body 3 to enable the mobile phone 4 to have the minimum raising angle.

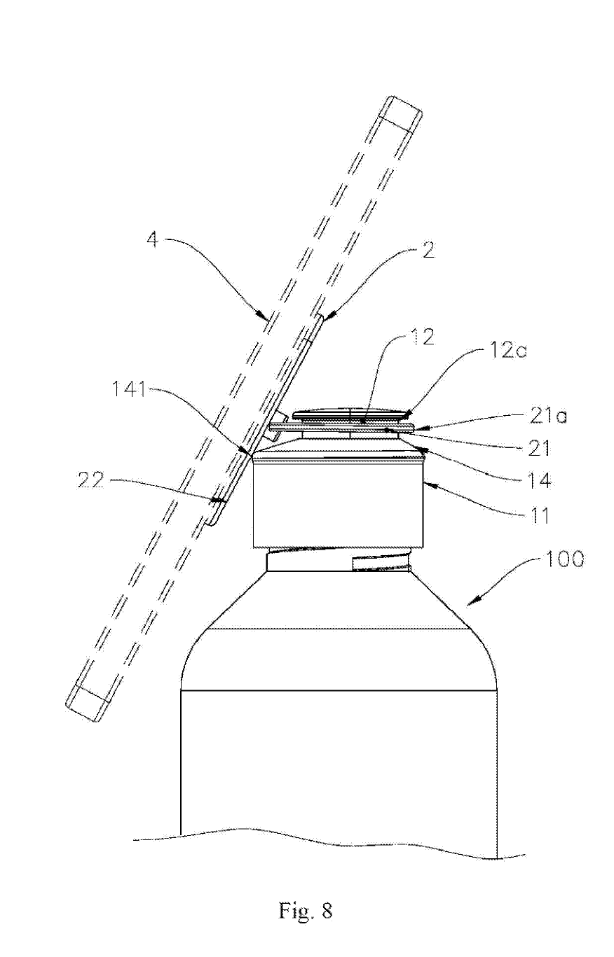

Referring to FIG. 8, FIG. 8 shows a schematic drawing of a second use state of the mobile terminal support. The mobile phone 4 is supported on the beverage bottle 100 by the mobile terminal ring buckle 2, and the propping point 21a on the ring member 21 of the mobile terminal ring buckle 2 is propped against the nearest limit position 12a on the first protrusion 12. Here, the distance from the mobile phone 4 to the center of the bottle cap main body 11 is the shortest, and the second side of the paste board 22 is propped against the annular protrusion 141 arranged at the joint of the periphery of the bottle cap main body 11 and the eccentric circular truncated cone 14 to enable the mobile phone 4 to have the maximum raising angle.

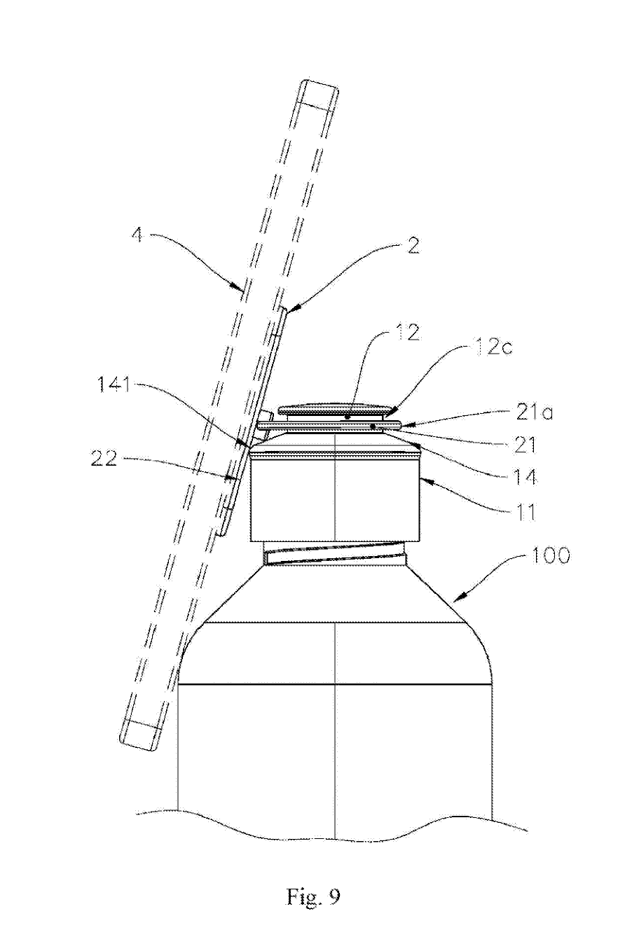

Referring to FIG. 9, FIG. 9 shows a schematic drawing of a third use state of the mobile terminal support. The mobile phone 4 is supported on the beverage bottle 100 by the mobile terminal ring buckle 2, and the propping point 21a on the ring member 21 of the mobile terminal ring buckle 2 is propped against a middle limit position 12c on the first protrusion 12. Here, the distance from the mobile phone 4 to the center of the bottle cap main body 11 is moderate, and the second side of the paste board 22 is propped against the annular protrusion 141 arranged at the joint of the periphery of the bottle cap main body 11 and the eccentric circular truncated cone 14, so that a raising angle of the mobile phone 4 ranges from the maximum raising angle to the minimum raising angle.

In a process during which the ring member 21 of the mobile terminal ring buckle 2 rotates relative to the first projection 12, the paste board 22 will always be propped against the annular protrusion 14, and meanwhile raising angles of the mobile phone 4 change linearly, as the bottle cap main body 11, the annular protrusion 14, the first protrusion 12 and the second protrusion 13 are respectively circular in cross section and if the influence of the bottle body 3 is ignored. Considering that the bottle body 3 inevitably exists in practice, when the ring member 21 rotates relative to the first projection 12 within a certain angle range, the mobile phone 4 will be propped against the peripheral surface of the bottle body 3, and meanwhile, the paste board 22 is not propped against the annular protrusion 14. The certain angle range covers any positive/negative angle generated in a rotating process of the mobile phone 4 from a rotating starting point where the propping point 21a of the ring member 21 is propped against the farthest limit position 12b till the paste board 22 is propped against the annular protrusion 14 and the mobile phone 4 is not in contact with the bottle body 3 any longer, irrespective of clockwise or counterclockwise rotation.

Of course, the first and second protrusions on the bottle cap 1 and the bottle cap main body are not limited to those with circular cross sections as described in the embodiments of the present invention, but the first protrusions, the second protrusions, and the bottle cap main bodies satisfying the following relations are intended to be included within the scope of the present invention.

In the axial direction of the bottle cap main body, the projection of the second protrusion on the bottle cap main body is entirely located within the peripheral contour line of the bottle cap main body, and the area of a surface encircled by the peripheral contour line of the second protrusion is smaller than that of a surface encircled by the peripheral contour line of the bottle cap main body.

In the height extending direction of the first protrusion, the projection plane of the first protrusion on the second protrusion is completely located within the peripheral contour line of the second protrusion, and the area of the projection plane of the first protrusion on the second protrusion is smaller than that of the surface formed by the peripheral contour line of the second protrusion.

This design ensures that the mobile phone and the second protrusion are unlikely to interfere with each other when the raising angle of the mobile angle is adjusted on the bottle cap through rotation of the mobile terminal ring buckle; and if the external contour line of the second protrusion is located outside the bottle cap main body, a raising angle of the mobile phone cannot be formed because of interference from the second protrusion. Meanwhile, this design ensures that after sleeving the first protrusion, the ring member is protected from loosening as the upper part and the lower part of the ring member are limited by the second protrusion and the bottle cap main body respectively.

Referring to FIG. 11, FIG. 11 shows a structural view of a connecting device. With reference to FIG. 3, FIG. 4, and FIG. 5, the structures of the main body of the connecting device 5, and of the first and second protrusions or the connecting relations thereamong in FIG. 11 are the same as the structures of the first protrusion 12 and the second protrusion 13 and the connecting relations among the first protrusion 12, the second protrusion 13 and the bottle cap main body 11 in the embodiments of the mobile terminal support shown in FIG. 3, FIG. 4 and FIG. 5, and will not be repeated herein.

The connecting device 5 is mainly used for compressing and tightly matching with the bottle cap on the beverage bottle or other supporters, which can be accommodated in the opening at the bottom of the connecting device 5, so three elastic matching cushion blocks 512 are uniformly distributed on the inner wall 511 of a bottle cap main body 51 of the connecting device 5 in the peripheral direction of the connecting device 5. The elastic matching cushion blocks 512 can be propped against the outer wall of the bottle cap 1, so that the connecting device 5 is adapted to be mounted on a beverage bottle having an ordinary bottle cap to retrofit the ordinary bottle cap into a bottle cap support. Alternatively, after the connecting device 5 stably sleeves a matching member at a fixed place through the elastic matching cushion blocks 512, and the mobile terminal ring buckle pasted with the mobile terminal sleeves the connecting device 5, reading or shooting images with the mobile phone in a fixed state can be realized in any scene.

Of course, the matching member in the opening of the connecting device 5 is not limited to the matching cushion block 512; the matching member in the opening at the lower end of the connecting device 5 may be a screw hole formed in the bottom surface of the opening, and is configured to match with a holder of the support or a selfie stick; and the matching member may be a thread formed on the inner wall of the opening to enable the connecting device 5 to serve as the bottle cap to match with the bottle body in use.

The lower part of the connecting device may not be provided with an opening; the matching member may be a screw hole part embedded in the lower end surface of the main body, and the screw hole part can be connected with a holder of a shooting tool such as a camera support or a selfie stick; and the matching member may be a cylindrical plug at the lower part of the connecting device main body for blocking and sealing a glass bottle body. There are many other embodiments for the connecting device, which will not be listed exhaustively.

Since the beverage bottle in the present invention has the same structure as the beverage bottle 100 in the embodiment of the mobile terminal support, and the connecting device in the present invention can be reflected from the structure of the bottle cap 1 in the embodiment of the mobile terminal support, the embodiments of the beverage bottle and of the connecting device can be reflected in the description of the embodiment of the mobile terminal support, and repeated description of the embodiments of the beverage bottle and of the connecting device is omitted here.

In the present invention, the bottle cap is retrofitted to enable a daily beverage bottle to match with widely used mobile terminal ring buckles to form the mobile terminal support. If a user's mobile phone is equipped with the mobile terminal ring buckle, he/she will get an additional mobile phone support when he/or puts a beverage bottle with the retrofitted bottle cap into his/her bag before going out, or brings with the separate connecting device 5 (shown in FIG. 11) and then buys a bottle of drinking water in a store, so that more convenient and user-friendly experience is brought to the user when he/or goes out and uses the mobile terminal to shoot pictures, record video, etc.

Finally, it should be emphasized that the foregoing descriptions are only preferred embodiments of the present invention, and do not intend to limit the present invention. It should be appreciated by those skilled in the art that the present invention may have various changes and alterations, and any variation, equivalent substitution and modification that falls within the spirit and principle of the present invention should be embraced by the protective scope of the present invention.

### INDUSTRIAL APPLICABILITY

The ring member of the mobile terminal ring buckle provided by the present invention may sleeve a protrusion; and in the rotating process of the mobile terminal ring buckle, different raising angles of the paste board may be formed; that is, a tilt angle of a mobile terminal screen is adjustable, so that the portable and universal mobile terminal support can be formed as long as the connecting device is mounted on the bottle body.

A smart mobile phone, a tablet computer or the like can be supported through the ring buckle or the beverage bottle provided by the present invention, so that the user does not need to hold an electronic device in his/her hand for a long time; and the smart device can be conveniently placed on a table, so that the user does not need to lower his/her head to watch the electronic device for a long time.

1. A connecting device for a mobile terminal support, the connecting device comprising a cylindrical main body with a matching member at the lower part thereof, wherein
an upper end of the main body is connected with a first protrusion, an upper end of the first protrusion is connected with a second protrusion, and the first protrusion is eccentrically arranged relative to the second protrusion;
in the axial direction of the main body, a projection plane of the second protrusion on the main body is completely located within a peripheral contour line of the main body, and the area of the projection plane of the second protrusion on the main body is smaller than that of the surface formed by the peripheral contour line of the main body; and
in the extending direction of the first protrusion, a projection plane of the first protrusion on the second protrusion is completely located within a peripheral contour line of the second protrusion, and the area of the projection plane of the first protrusion on the second protrusion is smaller than that of the surface formed by the peripheral contour line of the second protrusion.

2. The connecting device of claim 1, wherein
in the extending direction of the first protrusion, the cross sections of the first and second protrusions are both circular, and the second protrusion is coaxially arranged with the first protrusion.

3. The connecting device of claim 1, wherein
an eccentric circular truncated cone is connected between the main body and the first protrusion, an upper end surface of the main body is concentrically arranged with a lower end surface of the eccentric circular truncated cone, and a lower end surface of the first protrusion is concentrically arranged with an upper end surface of the eccentric circular truncated cone.

4. The connecting device of claim 3, wherein
a ring of annular protrusion is arranged at the joints between the eccentric circular truncated cone and the periphery of the main body.

5. The connecting device of claim 1, wherein
the lower end of the main body is open, and the matching member is arranged in an opening at the lower end of the main body; and
the matching member is a thread formed on the inner wall of the opening or a matching cushion block arranged on the inner wall of the opening.

6. The connecting device of claim 1, wherein
the matching member is a screw hole part arranged at the lower part of the main body.

7. A beverage bottle comprising a bottle cap and a bottle body, wherein the bottle cap comprises a cylindrical bottle cap main body; a matching member is arranged at the lower part of the bottle cap main body, and is matched with the bottle body to seal a mouth at the upper end of the bottle body;
the upper end of the bottle cap main body is connected with a first protrusion, the upper end of the first protrusion is connected with a second protrusion, and the first protrusion is eccentrically arranged relative to the bottle cap main body;
in the axial direction of the bottle cap, a projection plane of the second protrusion on the bottle cap main body is completely located within the peripheral contour line of the bottle cap main body, and the area of the projection plane of the second protrusion on the bottle cap main body is smaller than that of the surface formed by the peripheral contour line of the bottle cap main body; and
in the extending direction of the first protrusion, the projection plane of the first protrusion on the second protrusion is completely located within the peripheral contour line of the second protrusion, and the area of the projection plane of the first protrusion on the second protrusion is smaller than that of the surface formed by the peripheral contour line of the second protrusion.

8. The beverage bottle of claim 7, wherein
in the extending direction of the first protrusion, the cross sections of the first and second protrusions are both circular, and the second protrusion is coaxially arranged with the first protrusion.

9. A mobile terminal support comprising a mobile terminal ring buckle, wherein the mobile terminal ring buckle comprises a paste board, a rotating shaft and a ring member; the paste board comprises a first side and a second side opposite to the first side, a viscous layer is arranged on the first side, the rotating shaft is rotatably connected with the second side, and the ring member is rotatably connected with the rotating shaft; wherein,
the mobile terminal support further comprises a beverage bottle comprising a bottle cap and a bottle body, wherein the bottle cap comprises a cylindrical bottle cap main body; a matching member is arranged at the lower part of the bottle cap main body, and is matched with the bottle body to seal a mouth at the upper end of the bottle body; the upper end of the bottle cap main body is connected with a first protrusion, the upper end of the first protrusion is connected with a second protrusion, and the first protrusion is eccentrically arranged relative to the bottle cap main body;
in the axial direction of the bottle cap, a projection plane of the second protrusion on the bottle cap main body is completely located within the peripheral contour line of the bottle cap main body, and the area of the projection plane of the second protrusion on the bottle cap main body is smaller than that of the surface formed by the peripheral contour line of the bottle cap main body;
in the extending direction of the first protrusion, the projection plane of the first protrusion on the second protrusion is completely located within the peripheral contour line of the second protrusion, and the area of the projection plane of the first protrusion on the second protrusion is smaller than that of the surface formed by the peripheral contour line of the second protrusion; and
the ring member detachably sleeves the first protrusion, and the second protrusion limits the ring member.

10. The mobile terminal support of claim 9, wherein
in the extending direction of the first protrusion, the cross sections of the first and second protrusions are both circular, and the second protrusion is coaxially arranged with the first protrusion.
